(19) United States
(12) Patent Application Publication
(10) Pub. No.: US 2014/0379417 A1
(43) Pub. Date: Dec. 25, 2014

(54) System and Method for Data Quality Business Impact Analysis

(71) Applicants: Abhiram Gujjewar, Palo Alto, CA (US); David Kung, Palo Alto, CA (US); Ray Kuo, Palo Alto, CA (US); Min He, Palo Alto, CA (US); Cate Hanson, Palo Alto, CA (US)

(72) Inventors: Abhiram Gujjewar, Palo Alto, CA (US); David Kung, Palo Alto, CA (US); Ray Kuo, Palo Alto, CA (US); Min He, Palo Alto, CA (US); Cate Hanson, Palo Alto, CA (US)

(73) Assignee: BUSINESS OBJECTS SOFTWARE LTD, Dublin (IE)

(21) Appl. No.: 13/924,152

(22) Filed: Jun. 21, 2013

(51) Int. Cl. G06Q 10/06

(52) U.S. Cl. CPC G06Q 10/0635
USPC 705/7.28

(57) ABSTRACT

A computer implemented method of calculating a cost impact. The method includes associating cost amounts with various rules, using the rules to identify bad data, and calculating an aggregate cost of the bad data. In this manner, the Data Steward can prioritize various data quality improvement projects.

### CROSS REFERENCE TO RELATED APPLICATIONS

Not applicable.

### BACKGROUND

The present invention relates to data quality, and in particular, to calculating the cost impact of bad data.

Unless otherwise indicated herein, the approaches described in this section are not prior art to the claims in this application and are not admitted to be prior art by inclusion in this section.

Data quality is an important consideration for businesses. Examples of bad data include typographical errors, missing information (e.g., a required field in a data entry form), accurate data in an incorrect format, factually invalid data (e.g., a nonexistent postal code), determinatively invalid data (e.g., an email address is generating bounces), generally invalid data (e.g., the customer is in a country in which the business is not licensed to operate), etc.

Often a business will have a person or department in charge of data quality: the Data Steward. The Data Steward uses various computer-implemented tools to perform data stewardship functions, such as to identify bad data, to implement procedures to correct bad data, and to modify existing procedures in ways that result in less bad data.

### SUMMARY

Embodiments of the present invention improve data stewardship. Embodiments are directed toward tools for calculating the cost impact of bad data. By knowing the costs of various types of bad data, the Data Steward can more effectively devote resources to correcting the most costly problems.

In one embodiment the present invention includes a computer implemented method of calculating a cost impact of bad data. The method includes storing, by a computer system, a plurality of rules, wherein the plurality of rules relate to a plurality of data. The method further includes storing, by the computer system, a plurality of cost amounts, wherein each of the plurality of cost amounts corresponds to one of the plurality of rules. The method further includes processing, by the computer system, the plurality of data according to the plurality of rules to determine that a set of the plurality of data is invalid. The method further includes calculating, by the computer system, a cost of the set according to the plurality of cost amounts applied to the set.

The computer system may display a graph or bar chart of the costs arranged according to the rules. The computer system may display user interface elements (increment and decrement buttons, sliders, etc.) for performing what-if analyses.

A system may implement the above method, using a computer to calculate the cost impact of bad data. A computer readable medium may store a computer program for controlling a computer to implement the above method.

As a result, the system provides the Data Steward with a data quality financial impact scorecard which quantifies the impact of bad data in financial terms, identifies the problem areas that have biggest bang for the buck and prioritize them accordingly, and shows the return on investment on data projects undertaken in terms that are meaningful to strategic goals such as reducing cost, improving operation efficiency, margin, customer satisfaction and so on.

The following detailed description and accompanying drawings provide a better understanding of the nature and advantages of the present invention.

### BRIEF DESCRIPTION OF THE DRAWINGS

FIG. 1 is a block diagram of a computer system that implements the data quality cost impact system.

FIG. 2 is a flowchart of a method of calculating the cost impact of bad data.

FIG. 3 is a block diagram of an example computer system and network for implementing embodiments of the present invention.

### DETAILED DESCRIPTION

Described herein are techniques for calculating the cost impact of bad data. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

In this document, various methods, processes and procedures are detailed. Although particular steps may be described in a certain order, such order is mainly for convenience and clarity. A particular step may be repeated more than once, may occur before or after other steps (even if those steps are otherwise described in another order), and may occur in parallel with other steps. A second step is required to follow a first step only when the first step must be completed before the second step is begun. Such a situation will be specifically pointed out when not clear from the context.

In this document, the terms “and”, “or” and “and/or” are used. Such terms are to be read as having the same meaning; that is, inclusively. For example, “A and B” may mean at least the following: “both A and B”, “only A”, “only B”, “at least both A and B”. As another example, “A or B” may mean at least the following: “only A”, “only B”, “both A and B”, “at least both A and B”. When an exclusive-or is intended, such will be specifically noted (e.g., “either A or B”, “at most one of A and B”).

In this document, the term “server” is used. In general, a server is a hardware device, and the descriptor “hardware” may be omitted in the discussion of a hardware server. A server may implement or execute a computer program that controls the functionality of the server. Such a computer program may also be referred to functionally as a server, or be described as implementing a server function; however, it is to be understood that the computer program implementing server functionality or controlling the hardware server is more precisely referred to as a “software server”, a “server component”, or a “server computer program”.

In this document, the term “database” is used. In general, a database is a data structure to organize, store, and retrieve large amounts of data easily. A database may also be referred to as a data store. The term database is generally used to refer to a relational database, in which data is stored in the form of tables and the relationship among the data is also stored in the form of tables. A database management system (DBMS) generally refers to a hardware computer system (e.g., persistent memory such as a disk drive, volatile memory such as random access memory, a processor, etc.) that implements a database.

Introduction

In order to change the organization culture around managing quality, Data Stewards and other stakeholders in Information Governance organizations (e.g., those responsible for data governance in an organization) need to demonstrate how bad data impacts their business. The impact can be financial, customer satisfaction, operation efficiency, brand recognition and so on. There are various ways these different impacts can be calculated and visualized via reports, trend charts, color codes, alerts, notifications, etc.

Data Stewards need the ability to quantify and visualize these different types of impact, specifically the financial impact because it will connect the Financial ROI aspect to the Data Quality and Information Governance initiatives, that too at a given point of time as well as over a period of time. Data Stewards also realize that factors affecting the cost are variable and they want to be able to do some “what-if analysis” to answer questions like “What will happen to financial impact if I started a new data quality project and brought down the percentage of failed records to 10% down from 20%?” or “What is the financial impact if the real cost per failure is much higher than initially thought?”. They also want to see this in context of impact of bad data on downstream systems like data movement tools, data warehouse, reporting tools, etc.

The system described herein calculates the financial impact of bad data based on the failure of data quality validation rules and the impact of each such failure. Financial Impact Analysis enables business Data Stewards to do the following:

1. Estimate the cost per failure in a worksheet with different cost types such as revenue loss, staff overhead, sales costs, fees, etc.

2. Get insight into cost of bad data at different levels in the context of Data Quality Scorecard. They see aggregate cost at Key Data Domain level (or area of interest) and drill down to quality dimensions level (such as accuracy, consistency, conformity, etc.) and then at individual validation rule level. This calculation is based on the knowledge of how many records in fact failed the validation rules (based on rule validation engines outside this system) and what the impact of each failure is (input provided by Data Steward or subject matter expert). The cost for each validation rule is calculated as follows: Number of failed records*cost per failure. The cost per quality dimension is the sum of the costs of all validation rules for each quality dimension. The cost of the key data domain is the sum of the cost of all quality dimensions. Examples of key data domains are Product, Customer, Material, etc. Examples of quality dimensions are Accuracy, Completeness, etc.

3. Understand the trend the cost is following over a period of time, again based on historical data about how many records failed for different validation rules.

4. Perform what-if analysis to understand how variables like total records failed and cost per failure affects the overall financial impact. This helps them judge potential savings if the data quality is improved so that they can focus their initiatives on those areas.

As discussed earlier, bad data can affect many aspects of business. The system described herein addresses the financial impact of bad data based on data quality validation rule failure and cost impact per failure. Financial impact analysis performed by the system lets the Data Steward estimate how much money inaccurate data could be costing the organization. For example, inaccurate customer information in the enterprise resource planning system likely creates order delay and lost shipments. When the Data Steward wants to create an initiative to clean up the inaccurate customer data in the system, to justify the budget to cleanse and improve the data, the Data Steward uses the system described herein to conduct a financial impact analysis on the existing data to present to company decision-makers.

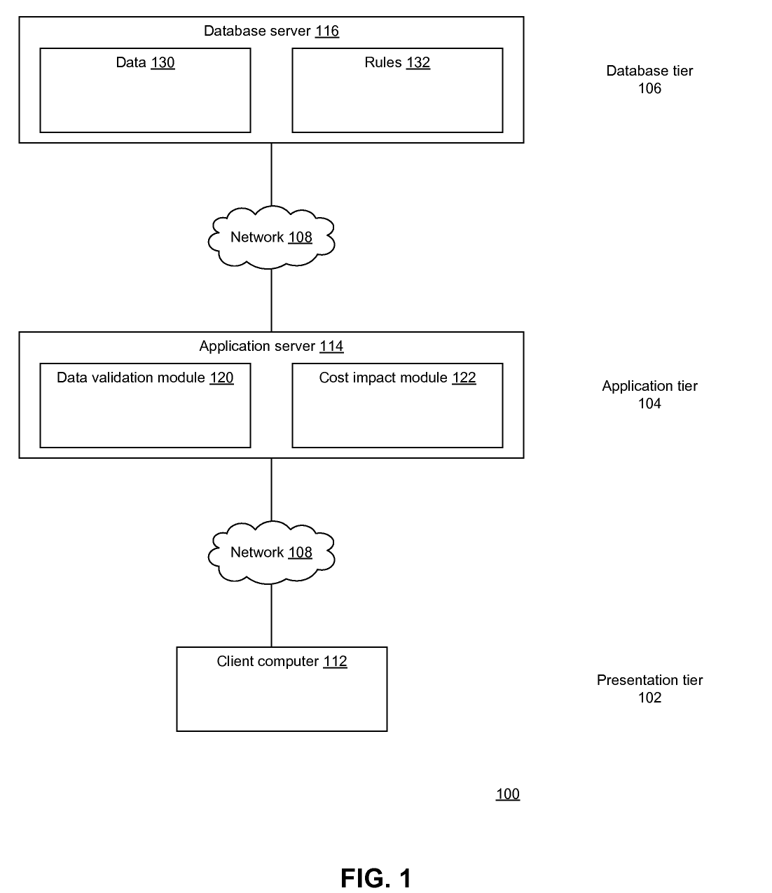

FIG. 1 is a block diagram of a computer system 100 that implements the data quality cost impact system. The system 100 is configured according to a three tier architecture, including a presentation tier 102, an application tier 104, and a database tier 106, connected via one or more networks 108 (e.g., a local area network, the internet, etc.).

The presentation tier 102 includes one or more client computers 112 that generally implement a user interface for a user to interact with the application tier 104. The client computer 112 generally includes a display for output, a keyboard and mouse for input, and a network connection to the network 108.

The application tier 104 includes one or more application servers 114 that generally implement the data quality cost impact system. The application server 114 includes a data validation module 120 and a cost impact module 122. The data validation module 120 generally performs the data validation functions, as further detailed below. The cost impact module 122 generally performs the cost impact functions, as further detailed below. The application server 114 may be implemented by a server computer or by one or more blades in a server rack.

The database tier 106 generally includes one or more database servers 116 that generally implement a database system. The database server 116 stores the data 130 that is the subject of the data quality analysis, as well as the rules 132 that the application server 114 uses to identify bad data in the data 130. In general, the data 130 corresponds to the operational data of the business, such as customer information, orders, invoices, product specifications, inventory data, supply chain data, human resources information, accounting information, etc.

Note that the core functionality of the data quality cost impact system is performed by the application server 114, so certain embodiments (e.g., small scale implementations) may omit the hardware in the presentation tier 102 and the database tier 106, with that functionality being performed by the hardware in the application tier 104, as well as omit the network 108.

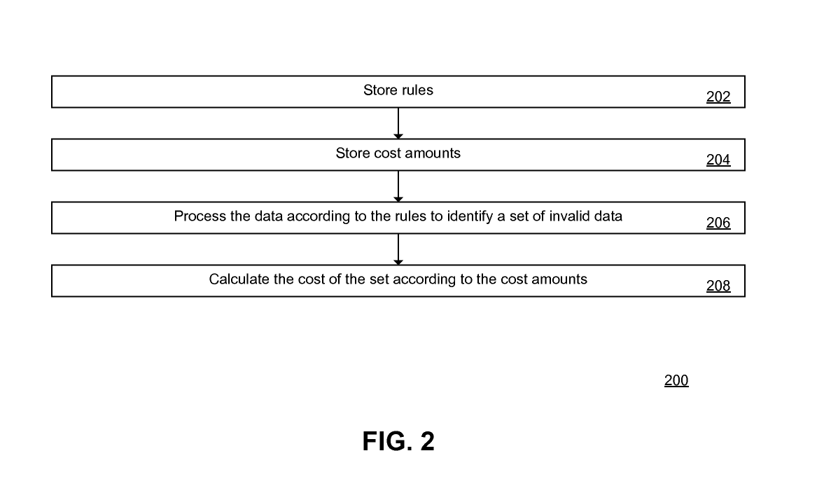

FIG. 2 is a flowchart of a method 200 of calculating the cost impact of bad data. The method 200 may be performed by the system 100 (see FIG. 1), e.g. specifically by the application server 114, for example as controlled by one or more computer programs.

At 202, the computer system stores the data validation rules. The data validation rules relate to the data to be evaluated by the rules. For example, if a rule is “Each customer must have a contact phone number”, then that rule relates to a customer information table in the database. The database server 116 (see FIG. 1) may store the data validation rules (e.g., the rules 132). The data may also be stored by the database server 116 (e.g., the data 130). Alternatively, the application server 114 may store the rules, or may instruct the database server 116 to store the rules.

At 204, the computer system stores cost amounts. Each of the cost amounts corresponds to one of the rules. For example, if a rule is “Each customer must have a contact phone number”, then the cost amount associated with that rule has a value, say $50. Further details on the cost amounts are provided below. The database server 116 (see FIG. 1) may store the cost amounts, for example with the rules.

At 206, the computer system processes the data according to the rules to determine that a set of the data is invalid. For example, for the “phone number” rule mentioned in 204, then the system applies that rule to the customer information table in the database to identify the records that fail that rule. The application server 114 (see FIG. 1) may request the rules and the data from the database server 116 for processing.

At 208, the computer system calculates a cost of the set according to the cost amounts applied to the set. For example, for the “phone number” rule mentioned in 204, if three records fail that rule, then the cost is $150. When there are multiple rules with different cost amounts, the cost of each failed rule may be computed, as well as the total cost. The application server 114 (see FIG. 1) may calculate the cost.

As mentioned above, the specific hardware configuration may vary according to the design needs of the data quality cost impact system. Thus the wording of the steps above should be read to cover the various configurations, even though for brevity the steps are discussed as being performed by the computer system, with the understanding that the application server 114 performs the core functionality. For example, when the system includes the application server 114 and the database server 116 (see FIG. 1), the wording “the computer system stores the data validation rules” (see 202) means that the application server instructs the database server to store the data validation rules.

Once the bad data has been identified and the corresponding costs calculated, the system may display the results in one or more charts (or graphs), such as bar charts, organized by individual rule or groups of rules. The system may allow the user to perform what-if analysis, for example by accepting input from text boxes, adjustment buttons or sliders to change the cost amounts or the number of records that fail a particular rule, and adjusting the results accordingly. Specific further details are provided below.

General Operation

The system includes three modules which have a graphical user interface and background computation logic: the Financial Impact Worksheet, the Financial Impact Views, and the What-If Analysis.

1. Financial Impact Worksheet

This worksheet helps Data Stewards calculate the financial impact of failure of a specific data quality validation rule. A given rule is associated with one or more line item costs. Each line item cost belongs to one of the 2 following categories: resource independent costs and resource dependent costs. For resource independent costs, the line item cost is a fixed amount. For example, if there is a tax or penalty associated with the bad data, the cost is set to the amount of the tax or penalty. As another example, if the bad data is a wrong address, the cost may include the postage spent on mailings. For resource dependent costs, the line item cost is the number of people involved in fixing the error times the hourly rate of their labor times the amount of time spent. The resource dependent cost may be associated with the bad data, but may not be specific to the people fixing the problem. For example, if two workers are dispatched to fix a leaky pipe but the address is wrong, the cost is their wasted time. The total line item cost is then the sum of all the individual line item costs.

The financial impact worksheet may be implemented as a form or spreadsheet in a graphical user interface. The resource independent costs may be selectable from pre-configured categories in a drop down list, such as “Fees and Charges” and “Revenue”; the cost for each line item may be entered in a text box. The resource dependent costs may also be selectable from pre-configured categories in a drop down list, such as “Staff Overhead”; the number of people, their labor costs, and the time spent may be entered in text boxes.

2. Financial Impact Views

The Financial Impact Views include two components: the Financial Impact Current Estimate and the Cost Trend Chart.

The Financial Impact Current Estimate helps Data Stewards understand the current financial impact of failure data quality validation rules for a given data set at different levels such as Key Data Domain, Quality Dimensions and Data Quality Validation rules. Key Data Domain is a data set or area of interest such as Customer, Product, etc. Quality Dimensions are specific quality aspects such as Completeness, Consistency, Conformity, Accuracy etc. These may be defined by users also. Data Quality Validation Rules are logical expressions that are applied to a record to determine if it meets expected criteria or quality aspect (a “passed” record) or it doesn't (a “failed” record). The user interface provides rule details, total number of records, actual failures, cost per failure and total cost. The financial impact at rule level is calculated as the product of number of records failed and cost per failure. The financial impact at Quality Dimension level is the sum of financial impact for all the rules in that dimension. The financial impact at Key Data Domain level is the sum of financial impact for all the dimensions.

Both tabular and graphical views are available as part of the user interface to support different personal visual preferences. In an example tabular view, the rules are grouped by Quality Dimension, then for each rule the number of records evaluated, the number that failed, the cost per failure, and the total cost are displayed; each Quality Dimension group may then have a subtotal, then the cost of all the Quality Dimension groups may be summed into an overall cost. In an example graphical view, the rules are grouped by Quality Dimension, then for each rule a bar chart is displayed that corresponds to the total cost of the records that fail.

The views may also be presented in summary and detail views. In the summary view, the user may select the key data domain, and the system displays the corresponding cost impact. In the detail view, the user may again select the key data domain, and the system displays the corresponding cost impacts grouped according to Quality Dimension; the user may then click on (or hover over) each Quality Dimension to expand out the corresponding rules and costs.

The Cost Trend Chart helps Data Stewards understand the costs of different dimensions relative to each other over a period of time. The trend is based on historical data on failures of different rules in different dimensions and respective costs per failure. For example, for each rule (or Quality Dimension), the historical costs may be displayed as different lines in a line chart, with dates on the x-axis and cost on the y-axis. When the user hovers over a point on the line, the system may display a popup with the details (rules or Quality Dimensions and cost impact) for that date.

3. What-If Analysis

This helps Data Stewards to change the number of failed records and the cost per failure, in order to understand the impact of such changes. The new impact follows the same mathematical calculations as the current estimate, but uses the changed values set by the user. It is important to note that in this type of analysis, users are not looking for an exact final number as the outcome. Instead, they want to know the range or level of change and directionality of the impact.

This interface also is available in tabular and graphical format, similar to those of the Financial Impact Current Estimate above. The number of failed records and cost may be adjusted with a slider or with increment/decrement buttons, at the granularity of individual rules or by Quality Dimension.

In the tabular format, the system may display the new impact as a “new total” next to the original cost, and may also display the difference before and after the changes, as a percentage or in absolute terms. In the graphical format, the system may display the new impact next to or overlapping the original cost, using different colored bars.

Cost Categories

As mentioned above, for each rule, the system enables the Data Steward to configure the associated costs. These estimates result in a total amount that represents the financial impact value of that rule per failure. Then, using the financial impact what-if analysis tool, the system enables the Data Steward to manipulate these values to simulate different scenarios.

Think in terms of the average annual financial impact per failure of this rule. For example, an erroneous record in the system could end up being employed multiple times over the period of a year if not corrected. So the cost would not be for just one occurrence but for the cumulative impact of using that record for a year.

The costs may be categorized into resource independent costs and resource dependent costs. Examples of resource independent costs include cash flow, fees, fixed overhead, revenue, sales, and other (a user-definable cost). The cash flow cost is the additional costs incurred to the organization's cash flow such as delays in recognizing revenue or making supplier payments. The fees cost is the costs associated with any additional expenses or direct fees such as those resulting from regulatory compliance failures. The fixed overhead cost is the fixed overhead cost distributed per failure such as storage costs due to returned shipments. The revenue cost is the loss of direct revenue such as lost customers or new sales. The sales cost is the additional costs associated with selling goods such as sales organizations following erroneous leads. Examples of resource dependent costs include staff overhead (with parameters of number of people, labor cost, and time), and other (a user-definable cost with user-definable parameters).

The financial impact calculation may be computed as follows. Each line item cost belongs to one of the following two categories:
1. Resource independent cost: line_item_cost=Fixed amount.
2. Resource dependent cost: line_item_cost=Labor Hourly Rate*Hour*Number of Resource.

The total line item cost is then:
Total line item cost: total_line_item_cost=Σ line_item_cost

The impact for each rule is then:
Financial Impact for each rule: rule_financial_impact=total_line_item_cost*Number_of_Rows_failed

The impact for each dimension is then:
Financial Impact for each dimension: dimension_financial_impact=Σ rule_financial_impact

The impact for each key data domain is then:
Financial Impact for each key data domain: kdd_financial_impact=Σ dimension_financial_impact

General Use Cases

The system provides cost impact data in a variety of formats for a variety of users. For business users (information systems users), the system enables them to open a financial impact analysis popup based on their key data domain, which can be filtered by the key data domain, so that they can see the overall impacts and nail down the issues. The system shows the detailed financial impacts on each level (key data domain, dimension, and rule) so that they can identify the impact on each area. The system shows the what-if value for the impact per failure amount on each rule so that they can identify how the cost per failed record impacts their business. The system shows the what-if value for the percentage of the failed records on each rule so that they can identify how the total failed records impacts their business. The system exports the what-if values to various formats (text file, Microsoft Excel™ file, character-separated values, etc.) so that they can review later or incorporate the data into a presentation or email. The system displays the financial impact in a bar chart and the cost trends in a line chart.

Rules

A validation rule is a specific type of business rule that checks whether the data complies with the business constraints and requirements. Validation rules are reusable functions. Each rule can have one or more input parameters that can be bound to table columns to measure data quality. Each input parameter can have an associated content type. The content type is used in automatically generated validation rules that are defined with the same content type.

To use the rule in a project, the Data Steward binds the rule to one or more table columns contained in the project. For example, you might have a rule that determines the number of rows that are not null. This rule can be bound to any or all of the columns in the table and can be used in other projects as well.

Creating Rules

Validation rules are created to check whether the data complies with the business constraints and requirements. The system may automatically suggest rules for certain columns after running a column profiling task. For example, the system can identify data that differs from the majority of information provided in a column, and then suggest that a rule be applied to a column. Rules may be automatically suggested for certain columns after running a content type profiling task. The Data Steward can view and edit the suggested rules before binding them to a column.

Likewise, the system can suggest that existing approved rules be applied to another column in the same project, or a different project.

Advanced Expressions for Rules

When the Data Steward creates or edits rules, the Data Steward can include simple expressions or can create more complex expressions using functions, variables, operators, strings, and so on.

Quality Dimensions

The system supports rules organized by, and analysis according to, a number of quality dimensions, including accuracy, completeness, conformity, consistency, integrity, timeliness, and uniqueness. Accuracy is the extent to which data objects correctly represent the real-world values for which they were designed. For example, the product must have a list price. Completeness is the extent to which data is not missing. For example, an order is not complete without a price and quantity. Conformity is the extent to which data conforms to a specified format. For example, the order date must be in the format YYYY/MM/DD. Consistency is the extent to which distinct data instances provide non-conflicting information about the same underlying data object. For example, the salary range for level 4 employees must be between $40,000 and $65,000. Integrity is the extent to which data is not missing important relationship linkages. For example, the date for putting a product for sale must be valid. Timeliness is the extent to which data is sufficiently up to date for the task at hand. For example, hats, mittens and scarves are in stock by November. Uniqueness is the extent to which the data for a set of columns is not repeated. For example, the new product name must be unique (not in the product master table).

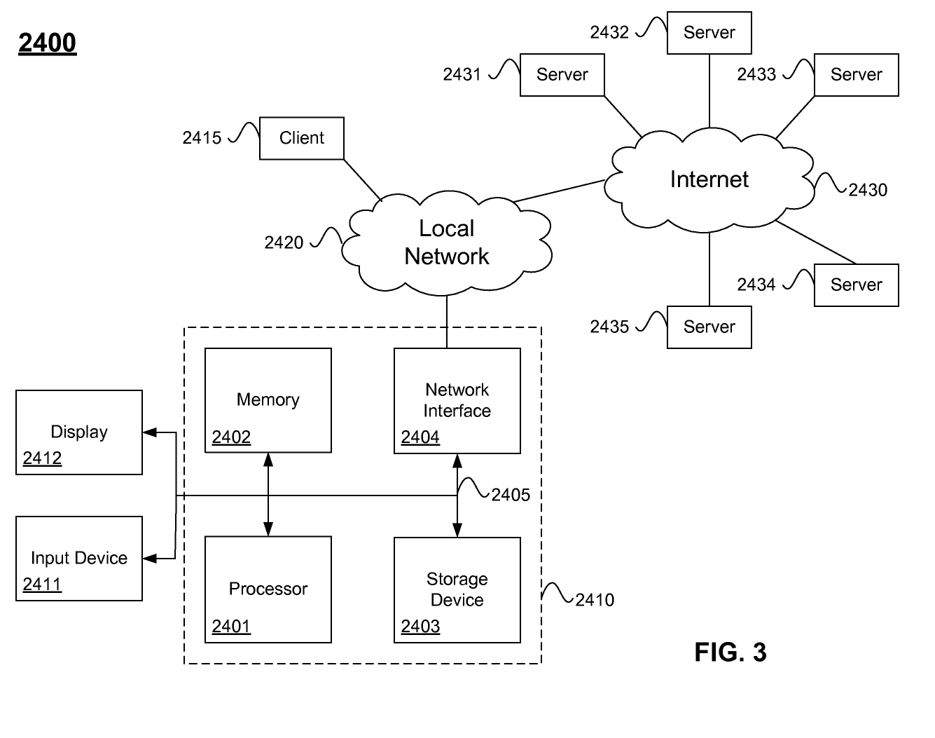

FIG. 3 is a block diagram of an example computer system and network 2400 for implementing embodiments of the present invention. Computer system 2410 includes a bus 2405 or other communication mechanism for communicating information, and a processor 2401 coupled with bus 2405 for processing information. Computer system 2410 also includes a memory 2402 coupled to bus 2405 for storing information and instructions to be executed by processor 2401, including information and instructions for performing the techniques described above. This memory may also be used for storing temporary variables or other intermediate information during execution of instructions to be executed by processor 2401. Possible implementations of this memory may be, but are not limited to, random access memory (RAM), read only memory (ROM), or both. A storage device 2403 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 2403 may include source code, binary code, or software files for performing the techniques or embodying the constructs above, for example.

Computer system 2410 may be coupled via bus 2405 to a display 2412, such as a cathode ray tube (CRT) or liquid crystal display (LCD), for displaying information to a computer user. An input device 2411 such as a keyboard and/or mouse is coupled to bus 2405 for communicating information and command selections from the user to processor 2401. The combination of these components allows the user to communicate with the system. In some systems, bus 2405 may be divided into multiple specialized buses.

Computer system 2410 also includes a network interface 2404 coupled with bus 2405. Network interface 2404 may provide two-way data communication between computer system 2410 and the local network 2420. The network interface 2404 may be a digital subscriber line (DSL) or a modem to provide data communication connection over a telephone line, for example. Another example of the network interface is a local area network (LAN) card to provide a data communication connection to a compatible LAN. Wireless links is also another example. In any such implementation, network interface 2404 sends and receives electrical, electromagnetic, or optical signals that carry digital data streams representing various types of information.

Computer system 2410 can send and receive information, including messages or other interface actions, through the network interface 2404 to the local network 2420, the local network 2421, an Intranet, or the Internet 2430. In the network example, software components or services may reside on multiple different computer systems 2410 or servers 2431, 2432, 2433, 2434 and 2435 across the network. A server 2435 may transmit actions or messages from one component, through Internet 2430, local network 2421, local network 2420, and network interface 2404 to a component on computer system 2410.

The computer system and network 2400 may be configured in a client server manner. For example, the computer system 2410 may implement a server. The client 2415 may include components similar to those of the computer system 2410.

More specifically, the client 2415 may implement a client-side interface for displaying information generated by the server, for example via HTML or HTTP data exchanges. The computer system 2400 may implement the system 100 described above (see FIG. 1 and related text), for example by executing one or more computer programs. For example, the computer system 2410 may implement the application server 114; the client 2415 may implement the client computer 112; and the server 2431 may implement the database server 116.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer implemented method of calculating a cost impact of bad data, comprising:
storing, by a computer system, a plurality of rules, wherein the plurality of rules relate to a plurality of data;
storing, by the computer system, a plurality of cost amounts, wherein each of the plurality of cost amounts corresponds to one of the plurality of rules;
processing, by the computer system, the plurality of data according to the plurality of rules to determine that a set of the plurality of data is invalid; and
calculating, by the computer system, a cost of the set according to the plurality of cost amounts applied to the set.

2. The computer implemented method of claim 1, wherein the cost is a plurality of costs, further comprising:
displaying, by the computer system, the plurality of costs arranged according to the plurality of rules.

3. The computer implemented method of claim 1, wherein the cost is a plurality of costs, further comprising:
displaying, by the computer system, the plurality of costs arranged according to the plurality of rules;
displaying, by the computer system, a plurality of user interface elements associated with the plurality of costs;
receiving, by the computer system, adjustment of one or more of the plurality of user interface elements according to a user input; and
recalculating the plurality of costs according to the adjustment of the one or more of the plurality of user interface elements.

4. The computer implemented method of claim 1, wherein the plurality of rules corresponds to a plurality of business rules that check whether the plurality of data complies with business requirements.

5. The computer implemented method of claim 1, wherein the plurality of cost amounts includes a plurality of resource dependent costs and a plurality of resource independent costs.

6. The computer implemented method of claim 1, wherein the plurality of cost amounts includes a plurality of resource dependent costs, wherein the plurality of resource dependent costs includes a staff overhead cost.

7. The computer implemented method of claim 1, wherein the plurality of cost amounts includes a plurality of resource independent costs, wherein the plurality of resource independent costs includes at least one of a cash flow cost and a sales cost.

8. The computer implemented method of claim 1, further comprising:
receiving, by the computer system, a user input that corresponds to editing the plurality of cost amounts; and
storing, by the computer system, the plurality of cost amounts having been edited,
wherein calculating the cost of the set includes calculating the cost of the set according to the plurality of cost amounts having been edited.

9. The computer implemented method of claim 1, further comprising:
receiving, by the computer system, a user input that corresponds to editing the plurality of rules; and
storing, by the computer system, the plurality of rules having been edited,
wherein processing the plurality of data includes processing the plurality of data according to the plurality of rules having been edited.

10. The computer implemented method of claim 1, further comprising:
receiving, by the computer system, a user input that corresponds to adding a new rule to the plurality of rules; and
storing the new rule with the plurality of rules,
wherein processing the plurality of data includes processing the plurality of data according to the plurality of rules and the new rule.

11. A system for calculating a cost impact of bad data, comprising:
an application server computer including a processor and a memory, wherein the application server computer is configured to instruct a database server to store a plurality of rules,
wherein the application server computer is configured to instruct the database server to store a plurality of cost amounts, wherein each of the plurality of cost amounts corresponds to one of the plurality of rules,
wherein the application server computer is configured to process the plurality of data according to the plurality of rules to determine that a set of the plurality of data is invalid, and
wherein the application server computer is configured to calculate a cost of the set according to the plurality of cost amounts applied to the set.

12. The system of claim 11, wherein the cost is a plurality of costs, wherein the application server computer is configured to generate a display of the plurality of costs arranged according to the plurality of rules, and
wherein the application server computer is configured to send the display to a client computer.

13. The system of claim 11, wherein the cost is a plurality of costs, further comprising:
a client computer, wherein the client computer is configured to display the plurality of costs arranged according to the plurality of rules,
wherein the client computer is configured to display a plurality of user interface elements associated with the plurality of costs,
wherein the application server computer is configured to receive adjustment of one or more of the plurality of user interface elements according to a user input, and
wherein the application server computer is configured to recalculate the plurality of costs according to the adjustment of the one or more of the plurality of user interface elements.

14. The system of claim 11, wherein the application server computer is configured to receive a user input that corresponds to editing the plurality of cost amounts, and
wherein the application server computer is configured to instruct the database server to store the plurality of cost amounts having been edited, wherein calculating the cost of the set includes calculating the cost of the set according to the plurality of cost amounts having been edited.

15. The system of claim 11, wherein the application server computer is configured to receive a user input that corresponds to editing the plurality of rules, and
wherein the application server computer is configured to instruct the database server to store the plurality of rules having been edited, wherein processing the plurality of data includes processing the plurality of data according to the plurality of rules having been edited.

16. A non-transitory computer readable medium storing a computer program for controlling a computer system to execute processing comprising:
a first storing component that is configured to control the computer to store a plurality of rules, wherein the plurality of rules relate to a plurality of data;
a second storing component that is configured to control the computer system to store a plurality of cost amounts, wherein each of the plurality of cost amounts corresponds to one of the plurality of rules;
a processing component that is configured to control the computer system to process the plurality of data according to the plurality of rules to determine that a set of the plurality of data is invalid; and
a calculating component that is configured to control the computer system to calculate a cost of the set according to the plurality of cost amounts applied to the set.

17. The non-transitory computer readable medium of claim 16, wherein the cost is a plurality of costs, further comprising:
a display component that is configured to control the computer system to display the plurality of costs arranged according to the plurality of rules.

18. The non-transitory computer readable medium of claim 16, wherein the cost is a plurality of costs, further comprising:
a first display component that is configured to control the computer system to display the plurality of costs arranged according to the plurality of rules;
a second display component that is configured to control the computer system to display a plurality of user interface elements associated with the plurality of costs; and
a user interface component that is configured to control the computer system to receive adjustment of one or more of the plurality of user interface elements according to a user input,
wherein the calculating component is configured to control the computer system to recalculate the plurality of costs according to the adjustment of the one or more of the plurality of user interface elements.

19. The non-transitory computer readable medium of claim 16, further comprising:
a user interface component that is configured to control the computer system to receive a user input that corresponds to editing the plurality of rules,
wherein the first storing component is configured to control the computer system to store the plurality of rules having been edited, wherein processing the plurality of data includes processing the plurality of data according to the plurality of rules having been edited.
